(19) United States
(12) Patent Application Publication
(10) Pub. No.: US 2023/0204166 A1
(43) Pub. Date: Jun. 29, 2023

(54) OBSERVATION SYSTEM, LOCATION AND IDENTIFICATION OF DAMAGE IN PIPELINES

(71) Applicants: Petróleo Brasileiro S.A. - Petrobras, Rio de Janeiro (BR); Universidade Federal Do Rio De Janeiro - UFRJ, Rio de Janeiro (BR)

(72) Inventors: Italo Marcio Madeira, Rio de Janeiro (BR); Felipe Sant'Anna Nunes, Rio de Janeiro (BR); Victor De Souza Ferreira, Rio de Janeiro (BR); Elton Jorge Brabança Ribeiro, Rio de Janeiro (BR); Elias Do Carmo Dias, Rio de Janeiro (BR); Gabriel Dos Santos Laurindo, Rio de Janeiro (BR); Iasmin Louzada Herzog, Rio de Janeiro (BR); Marcelo José Colaço, Rio de Janeiro (BR); Mohsen Alaeain, Rio de Janeiro (BR); Raphael Costa Carvalho, Rio de Janeiro (BR); Helcio Rangel Barreto Orlande, Rio de Janeiro (BR); Bruno Dos Reis Jaccoud, Rio de Janeiro (BR); Luiz Carlos Macedo De Oliveira Filho, Rio de Janeiro (BR); Matheus De Abreu Monteiro Campos, Rio de Janeiro (BR); Paulo Veiga Da Trindade, Rio de Janeiro (BR); Inoussa Tougri, Rio de Janeiro (BR); Andre Ferreira, Rio de Janeiro (BR)

(21) Appl. No.: 18/146,097

(22) Filed: Dec. 23, 2022

(30) Foreign Application Priority Data
Dec. 29, 2021 (BR) 10 2021 026692 9

(51) Int. Cl. F17D 5/06; G06F 8/30

(52) U.S. Cl. CPC F17D 5/06; G06F 8/315

(57) ABSTRACT

The present invention provides the use of usual operational sensors of pressure, temperature, flow and specific mass already installed and available in oil and gas pipelines and methods of statistical inference, optimization and artificial intelligence that allow detection and location of leaks in pipelines. The invention has the following components: sensor communication module (1); statistical tools for compensation of measurement and model uncertainties (2); automatic leak detection techniques (3); leak locator (4); graphical user interface (5); measuring sensors (6); flow simulator (7); historical database (8).

### FIELD OF INVENTION

The present invention is related to the pipeline area with available measurement where fluids that may be in the liquid state flow, in the gaseous state, or mixtures thereof, and which are subject to damage, mainly leaks, either by accidents or by vandalism. The invention is a platform that involves measurement and data storage hardware and software that uses measured observation to estimate states of magnitudes that are not directly measured or where measurement is impossible. The invention is applied in the magnitudes estimates inference which, in this case, are start or end instants of leaks, their location a priori unknown.

### DESCRIPTION OF THE STATE OF THE ART

In the case of leaks in pipelines, there is no single efficient method for detection and location. There are solutions for closed column pipelines (liquid phase only), but not for open column pipelines (with liquid and gaseous phase) nor for gas pipelines (compressible flow and gaseous phase only). Current techniques normally use only one type of sensor, as is the example of negative pressure wave techniques, where only pressure sensors are considered, or the mass balance method, wherein only flow rate sensors are used and there is the checking of the inlet and outlet mass amount of the pipeline. There are also methods that seek to follow the transient behavior of the quantities variations in the pipeline over time, such as the RTTM—Real Time Transient Model (Transient simulation model in real time, which uses the solution of conservation equations, for a direct comparison with the measurements). Commercial systems in general only use sensors that are proprietary of the solution, that is, specific ones that require intervention in the installation and that eventually open gaps to information leakage. Current methods use specific sensors with high frequency data acquisition, which provides a large amount of information for these sensors. In the present invention, operational sensors already available for the pipeline operation are used. Operational sensors are usually of low acquisition frequency, that is, they bring little information about the phenomenon, however multiple sensors measurements are used together, thus providing a larger group of information allowing the proposed algorithm to perform the inference and therefore the estimate of the searched parameters, even with little information. These methods use real-time measurement of what is happening in the pipeline, however these algorithms are very dependent on the configuration they are set to work with, so once a detection is lost it will not appear in the current alarm list. The present invention allows the application of the algorithms even in historical measurements, preventing events from being lost even if they pass undetected during the real measurement time.

Document WO2021211785A1 refers to a system for detection or prediction of a leak in a pipe system that includes a data source with characteristics of a pipe system, a prediction module, and an interface coupled between the data source and the prediction module, wherein the prediction module includes at least one processor and is configured via executable instructions to receive the characteristics of the pipe system via the interface, evaluate the characteristics of the pipe system utilizing markers, each marker representing a physical condition of the pipe system, and identify or predict a leak in the pipe system based on a specific combination of markers.

Document BRP10604996A discloses a fluid leak detector for a hose line segment that has an inner housing and an outer housing separated by a collection space, wherein the detector has a sensor housing defined by sidewalls mounted externally to the hose line segment of the pipe and having an internal housing chamber in communication with the collection space.

Document CN2758724Y discloses a leak detector of a liquid pressure pipe, which comprises two vibration sensors, two paths of high pass filtering circuit, fitted at both ends of the pipe to be measured to collect the time-domain signal and frequency-domain signal from leakage noise and constant current source circuit.

Prior arts disclose systems used to detect leaks in pipes. However, the cited prior art presents deficiencies in compensation of measurement uncertainties and tools for that.

In view of the difficulties present in the state of the art mentioned above, and for solutions to observation, location and identification of damage in pipelines, it arises the need to develop a technology capable of effectively performing and that is in accordance with environmental and safety guidelines. The state of the art above mentioned does not have the unique characteristics that will be presented in detail below.

### OBJECT OF THE INVENTION

It is an object of the invention to enable quick decision-making in order to mitigate the problem, avoiding greater losses and damages to the population, the environment, as well as financial losses.

It is also an object of the invention to monitor the pipes in real time with immediate warning of leak events, followed by a procedure for geographically locating the leak position, as well as its start time.

### BRIEF DESCRIPTION OF THE INVENTION

The present invention provides the use of usual operational sensors of pressure, temperature, flow and specific mass already installed and available in oil and gas pipelines and methods of statistical inference, optimization and artificial intelligence that allow detection and location of leaks in pipelines.

The invention has the following components: sensor communication module (1); statistical tools for compensation of measurement and model uncertainties (2); automatic leak detection techniques (3); leak locator (4); graphical user interface (5); measuring sensors (6); flow simulator (7); historical database (8).

### BRIEF DESCRIPTION OF DRAWINGS

The present invention will be described in more detail below, with reference to the attached figures which, in a schematic and not limiting of the inventive scope, represent examples of its realization. The drawings show:

FIG. 1 illustrates the system of the present invention;

FIG. 2 illustrates the test sequence for decision making;

FIG. 3 illustrates the Recurrent Neural Network with 5 inputs and 1 outlet neuron;

FIG. 4 illustrates the steps of the SIR algorithm;

FIG. 5 illustrates the Markov Chain (a) and Posterior Histogram (b) for a Leakage at 7,950 m;

FIG. 6 illustrates the Markov Chain (a) and Posterior Histogram (b) for a Leakage at 30,000 m

FIG. 7 illustrates the Markov Chain (a) and Posterior Histogram (b) for a Leakage at 50,000 m

FIG. 8 illustrates the pressure and flow transients at the beginning (sensor 1) and at the end of the pipeline (sensor 13), obtained with the complete model, for the leak position at 37,6973 m;

FIG. 9 illustrates the pressure and flow transients at the beginning (sensor 1) and at the end of the pipeline (sensor 13), obtained with the complete model, for the leak position at 75.89465 m;

FIG. 10 illustrates simulated measurements obtained from the full model solution by adding Gaussian noise;

FIG. 11 illustrates (a) Pressure on sensor 1, (b) amplification of the region where oscillations occur, (c) model error;

FIG. 12 illustrates (a) Pressure on sensor 13, (b) amplification of the region where oscillations occur, (c) model error;

FIG. 13 illustrates (a) Flow rate in sensor 1, (b) amplification of the region where oscillations occur, (c) model error;

FIG. 14 illustrates (a) Flow rate in sensor 13, (b) amplification of the region where oscillations occur, (c) model error;

FIG. 15 illustrates results of the inverse problem with MCMC, for the first test case: (a) Markov chain and (b) acceptance rate;

FIG. 16 illustrates results of the inverse problem with MCMC, for the second test case: (a) Markov chain and (b) acceptance rate;

FIG. 17 illustrates results of the inverse problem with MCMC, for the third test case: (a) Markov chain and (b) acceptance rate.

### DETAILED DESCRIPTION OF THE INVENTION

Below follows a detailed description of a preferred embodiment of the present invention, by way of example and in no way limiting. Nevertheless, it will be clear to a person skilled in the art, from the reading of this description, possible additional embodiments of the present invention further comprised by the essential and optional features below.

Prior to the invention, systems could only see real time. The invention makes it possible to investigate leaks in the history, including allowing to evaluate with new search parameters, leaks that could not be detected and located in real time. By recording the results of geolocalized leaks, the invention allows the interpretation of regions more prone to new leaks, enabling more effective localized prevention investments.

The classical approaches in general do not consider measurement errors in the sensors, nor uncertainties in the physical characteristics of the flowing fluid. This invention uses a statistical approach, which takes into account such factors and, therefore, does not require specialized instrumentation, being able to benefit from instruments already installed in the field. In addition, it uses artificial intelligence techniques that recognize leak patterns, reducing the time needed to identify and locate them.

The main object of this invention is the DETECTION and LOCATION of leaks in pipelines, as this is currently extremely important, since it directly involves financial loss, as well as potential risks to the environment and neighboring populations, especially when it comes to petroleum-derived fluids. The invention uses the usual operational pressure, temperature, flow and specific mass sensors already installed in oil and gas pipelines and contemplates both single-phase and two-phase flows, and uses methods of statistical inference, optimization and artificial intelligence to achieve its objective.

The system proposed by the present invention comprises: sensor communication module (1), statistical tools (2) for compensation of measurement and model uncertainties, automatic leak detection techniques (3), graphical user interface (5), measurement sensors (6), leak locator (4), flow simulator (7), historical database (8).

The operation is as follows: the communication module with the sensors (1) receives the field data from the measurement sensors (6) and passes it to the statistical tools (2), which performs automatic error compensation, delivering the measurements to the automatic leak detection techniques (3) which, through the detection of patterns previously trained through the flow simulator (7) analyzes the measurement data from (1) or (8), for the possible detection of a leak. If there is a leak, the leak locator (4) is activated to locate it in the space and time. All command and results are done through the graphical interface (5) which also displays the leaks in a georeferenced way.

The measurement data, acquired in real time, are stored in a database and are read by the system.

After reading the data, it undergoes a correction algorithm based on filling in missing data and compensating measurements with apparent systematic errors.

The invention performs three main tasks, the first being the correction of the data, the second the DETECTION of leaks, which means that it was possible to create an alarm indicating that a leak is happening and the third task is the LOCATION of the leak in the pipeline.

DETECTION has a module that remains running in real time, monitoring the latest measurements in search of indication that the leak is currently occurring.

Unlike other systems, detection uses multiple approaches to identify leaks. This redundancy can be seen as confirmation of leak or as the sole criterion in case greater sensitivity is required.

The multiple DETECTION techniques can be turned on or off according to the greater or lesser sensitivity needed to monitor each particular pipeline.

The first DETECTION technique analyzes the variation rates of the monitored magnitudes and identifies the leak signature according to the signal behavior of these rates happening simultaneously and thus verifies the leak signature through sequential logic. The second technique uses a trained neural network to identify the rates of change and recognize the so-called leak signature. The third technique observes the statistical behavior of the measurements, being compared with the normal behavior without expected leakage. If there is an escape from normality, this statistical system indicates alarms with the start and end times of the leak.

Data is provided in Excel files, which are converted to Sqlite database and synchronized so that, when making a query for a specific date, if there is no measurement at 00:00:00, the value is taken at the next available instant. As in the file provided there is only a measurement record from the sensors when there is a change in the measurement greater than the respective deadband, the data is populated every second, so that, when there is no measurement available, the value available in the previous time is adopted. After complementing the data, moving averages of a period of 300 seconds are calculated every second. Moving averages are used to smooth out small swings in the sensor signals.

The respective informed deadbands were considered as standard deviations of the measures: 0.002 g/cm³ for specific mass, 2.0 m³/h for volumetric flow and 0.01 kgf/cm² for pressure.

A code in Python was used, in which different stages of sensor data preparation are performed, then performing hypothesis tests to detect events that may characterize leaks in the pipeline. The procedure performed in the code is:

1) Reading measurements from the sqlite database for a user-specified period of time.
2) Correction of the specific mass measured in Guararema
3) Correction of the measured volume flow in Guararema and Guarulhos.
4) Synchronization of all data to 00:00:00 (HH:MM:SS) of the chosen start date for searching in the database
5) Conversion of dates and times to seconds, counting from 00:00:00 (HH:MM:SS) of the initial date chosen for searching in the database.
6) Completion of data every second.
7) Calculation of the moving averages of measurements every second.
8) Calculation of the event indicator codes in the pipeline, according to the hypothesis tests specified in table 1

Six event indicator codes illustrated in Table 1 were calculated, based on variations in flow, pressure and specific mass, which indicate some characteristic of the pipeline flow at a given moment, such as, for example, pressure drop in one of the sensors or flow difference between Guararema and Guarulhos. The values of the variables used for the calculation of such indicator codes were the moving averages every second. If the test is true, the value of the corresponding code is 1. Otherwise, it is zero.

Code 6 is a combination of the previous ones and is intended to indicate leak. Two separate situations were analyzed for leak indication: pipeline stopped and pipeline in operation. For the case of a pipeline in operation, it was considered that there is a leak if there is a difference in mass flow and volume flow between the pipeline inlet and outlet, and if there is a drop in pressure in at least one of the pipeline ends. For the case of a stopped pipeline, only pressure variations were considered, since the flows are zero.

The flowchart in FIG. 2 illustrates the sequence of tests for decision making regarding the existence of leaks, using the codes shown in Table 1. In relation to the tests reported in Report 2, this flowchart presents greater simplicity and coherence, which resulted in a higher hit rates, as will be evident later in this section.

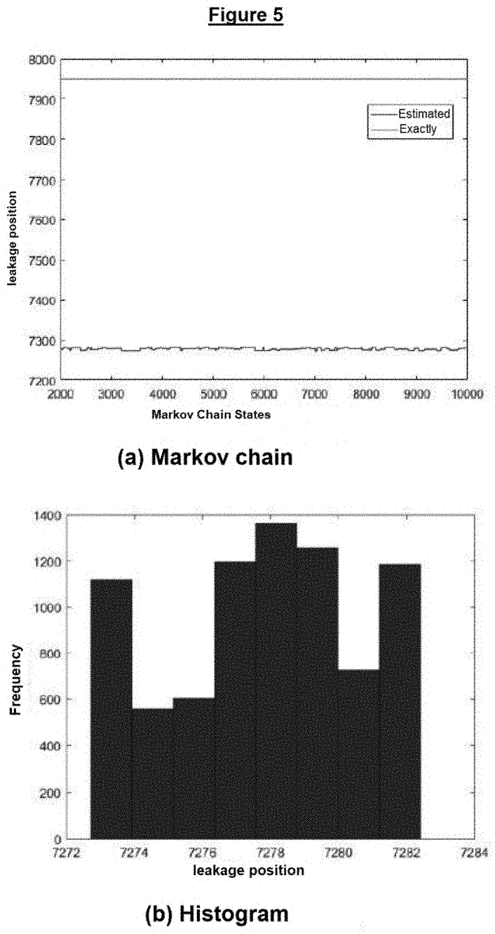

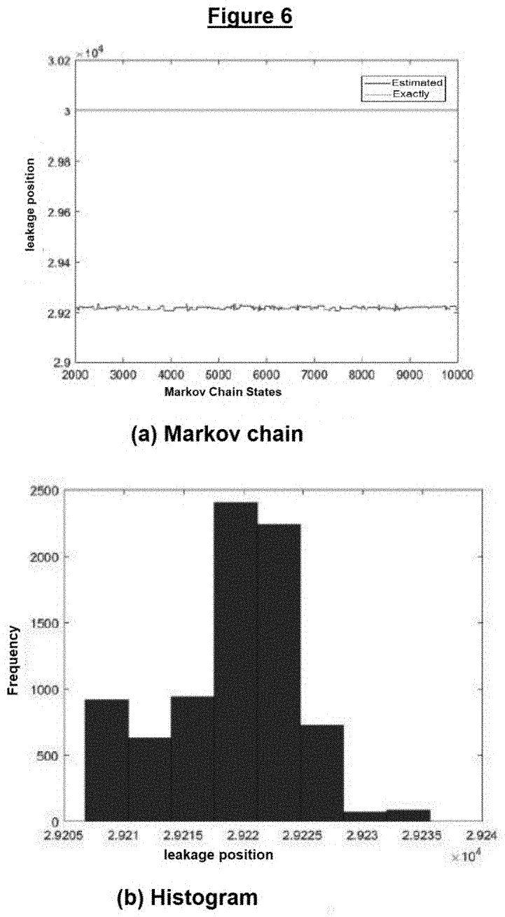

TABLE 1
Event indicator codes in the pipeline
and their respective hypothesis tests.

| Code | Event | Test |
|---|---|---|
| 1 | Stopped | Zero volumetric flow in Guararema and |
| | pipeline | Zero volumetric flow in Guarulhos - |
| | | Unilateral tests |
| 2 | Empty | Zero specific mass in Guararema and zero |
| | pipeline | specific mass in Guarulhos |
| | | Zero pressure in Guararema and zero pressure |
| | | in Guarulhos - Unilateral tests |
| 3 | Volume | Non-zero difference between the volumetric |
| | flow rate | flow in guararema and the volumetric flow in |
| | difference | guaruhos - Unilateral Test |
| 4 | Mass flow | Non-zero difference between the mass flow |
| | difference | in Guararema and the mass flow in Guaruhos - |
| | | Unilateral Test |
| 5gar | Pressure drop | First derivative of negative pressure in |
| | in Guararema | Guararema Unilateral Test |
| 5gru | Pressure drop | First derivative of negative pressure in |
| | in Guarulhos | Guarulhos Unilateral Test |
| 6 | Leak | See flowchart in FIG. 5.1.2 |

With the application of code 6, shown in FIG. 2, 1244 possible leaks were found, of which 31 are confirmed leaks, which corresponds to 79% of hits. In the appendix are presented the start (code 6=1) and end (code 6=0) times of each of the leaks detected herein.

A neural network with two layers of neurons is used, wherein the intermediate layer of the network has feedback of the Long Short-Term Memory (LSTM) type. This model estimates the probability of leakage at a given instant of time, based on 5 indicators associated with the state of the flow and the operation of the pipeline at that instant. These 5 indicators are calculated from pressure and flow measurements at the beginning and end of the pipeline and act as neural network inputs. Its possible values are presented in table 2.

TABLE 2
Neural network input variables.

| | | | Input |
|---|---|---|---|
| | | | variable |
| Inlet | Indicator | Description | value |
| 1 | Stopped | Null flow rates | X₁ = 1 |
| | pipeline | Non-zero volumetric flow rate at | X₁ = 0 |
| | | the pipeline inlet and/or outlet | |
| 2 | Volumetric | Volumetric flow rate difference between | X₂ = 1 |
| | flow rate | pipeline inlet and/or outlet | |
| | diffference | Same volumetric flow rate in the | X₂ = 0 |
| | | pipeline inlet and/or outlet | |
| 3 | Mass | Mass flow difference between the | X₃ = 1 |
| | fow rate | pipeline inlet and outlet | |
| | difference | Same mass flow in the pipeline | X₃ = 0 |
| | | inlet and outlet | |
| 4 | Pressure | Zero derivative of the pressure at | X₄ = 0 |
| | derivative | the beginning of the pipeline | |
| | at the | Negative derivative of the pressure | X₄ = 1 |
| | pipeline | at the beginning of the pipeline | |
| | inlet | Positive derivative of the pressure | X₄ = −1 |
| | | at the beginning of the pipeline | |
| 5 | Pressure | Zero derivative of the pressure at | X₅ = 0 |
| | derivative | the end of the pipeline | |
| | at the | Negative derivative of the pressure | X₅ = 1 |
| | pipeline | at the end of the pipeline | |
| | inlet | Positive derivative of the pressure | X₅ = −1 |
| | | at the end of the pipeline | |

The outlet variable assumes the discrete values 1, when there is a leak, or 0, when there is no leak. However, when used to make predictions, the neural network returns a continuous scalar variable, which informs the probability of having a leak or not at a given instant of time. That is, this network is a single-class classification model that informs whether or not a given sample belongs to the “leak” class. Because it is a single class classifier, the network has 1 single neuron in the outlet layer. In FIG. 3 we see the architecture of this model, with 5 inputs, 256 neurons in the hidden layer and 1 neuron in the outlet layer.

The detection is done with a program developed in Python, which must receive as inputs the initial and final dates and times of the period to be analyzed. In summary, the program performs the steps described below:
1. database connection to import pressure, volumetric flow and specific mass measurements, at the beginning and end of the pipeline, for the selected period;
2. correction of systematic error in specific mass in Guararema;
3. correction of isolated null values in the flow rate;
4. if there is no measurement at the initial instant of the analyzed period, the first measurement available in the period is used at this instant;
5. measurements are completed every second, repeating the previous measurement;
6. calculation of moving averages every 5 seconds, to reduce the influence of noise;
7. calculation of pressure derivatives;
8. calculation of the 5 leak indicators (pipe stopped, difference in mass flow, difference in volumetric flow, non-zero derivative at inlet, non-zero derivative at outlet);
9. prediction of the probability of having a leak with the neural network; 10. agglomeration of nearby alarms.

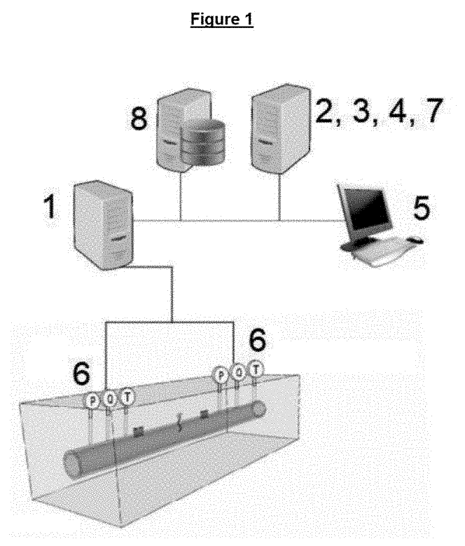

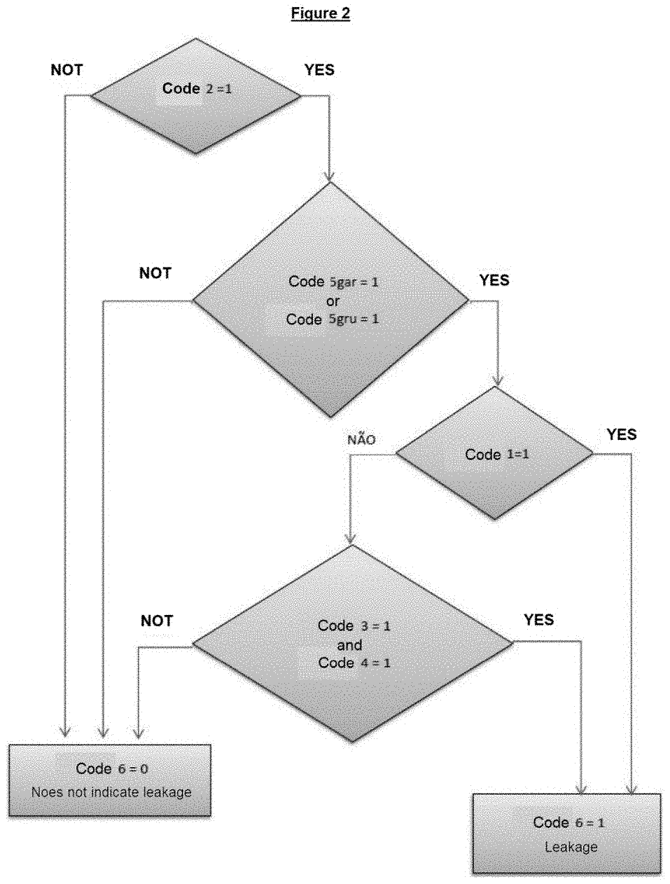

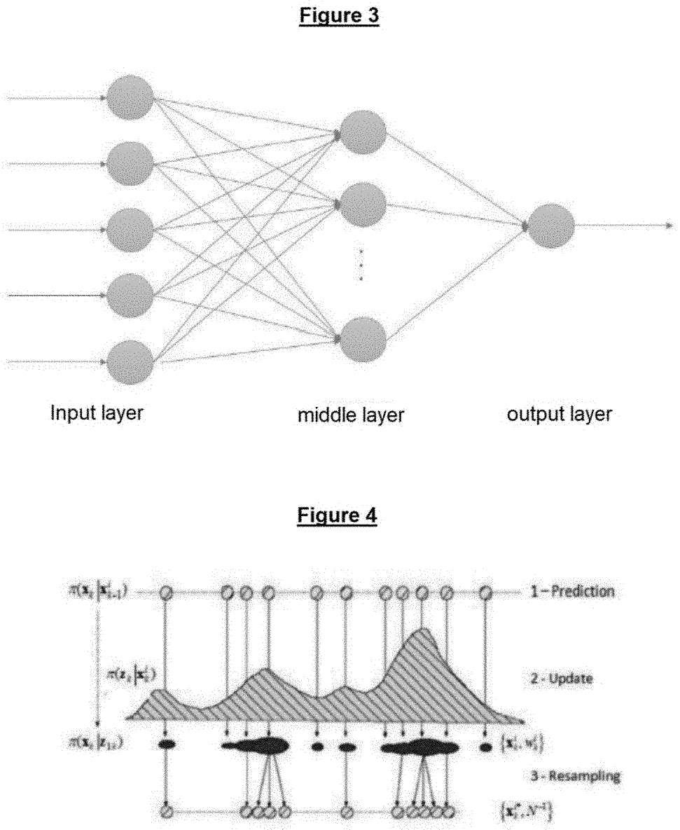

The invention also uses the Particle Filter method, where the idea is to represent a posteriori the probability density function by a set of random samples (particles) with associated weights and obtain estimates based on these samples and weights. Among the implementation algorithms of the Particle Filter method, the application of the Sequential Importance Resampling (SIR) algorithm is chosen. The SIR algorithm has the benefit of overcoming degeneracy effects where after a few states all particles have irrelevant weight except for one. Thus, particles with low associated weight are eliminated and new particles are generated from those with higher weights. Although the weights are easily calculated and the importance density is easily sampled, the phenomenon of particle impoverishment, characterized by the loss of diversity, can occur, especially when the noise/uncertainties of the problem are very small. (ARULAMPALAM et al., 2001; ORLANDE et al., 2012; RISTIC et al., 2004). The steps of the Particle Filter method with the Sequential Importance Resampling (SIR) algorithm are illustrated in FIG. 4 and presented in Table 3.

In the steps illustrated in FIG. 4, first, there are particles with uniform weight at the time instant t=tk; second, the particle weights are updated after the measurements; third, there is the resampling step. In this step, the total number of particles remains the same. However, particles with lower weight are discarded and those with higher weight give rise to new particles close to regions of higher probability; and fourth, there are particles with uniform weights at the time instant t=tk+1.

TABLE 3
Particle Filter Steps with the SIR Algorithm

```
  Step 1
For i = 1,...,N generate new particles x [symbol]  of the a priori density [symbol] ( x [symbol]  | [symbol] )
Use the likelihood function w [symbol] = [symbol] (y [symbol] |x [symbol] ) to calculate the weights
  Step 2
  Calculate the total weight w [symbol] = Σ [symbol] ^{N}w [symbol]
  Normalize the particle weights, that is, to i = 1,...,N , w [symbol] = (w [symbol] )⁻¹ w [symbol]
  Step 3
  Resample the particles as follows:
Construct the cumulative sum of weights(CSW)by computing c [symbol] = c [symbol] + w [symbol] with c [symbol] = 0
  Set i = 1 and generate a starting point u [symbol] of the uniform distribution
  For j = 1,...,N
      Go through CSW doing uⱼ = u [symbol] + N⁻¹(j−1)
    While u [symbol] > c [symbol] do i = i + 1
  Assign x [symbol] = x [symbol] and Assign w [symbol] = N⁻¹ [symbol]
indicates data missing or illegible when filed
```

The use of the Particle Filter for the solution of the state estimation problem incorporates the modeling of the physical problem for the detection of leaks, where the modeling uncertainties are also accounted for, in addition to the experimental uncertainties. As the model used does not consider leaks, a possible difference between the estimates obtained with the Particle Filter and the experimental measurements can be associated with the existence of a leak in the pipeline.

The application of the method focuses on the OSVAT-GG22 pipeline, between Guararema and Guarulhos, with a length of approximately 58 km. The objective at the moment is to evaluate the operation of the Particle Filter to estimate the state variables of the problem, that is, the pressures and flows along the pipeline and, consequently, to evaluate the efficiency of the Particle Filter in detecting leaks using the experimental measurements of pressure and flow at the pipeline inlet and outlet. Two different detection arrangements were tested: i) the inlet pressure and outlet flow rate measurements are used as boundary conditions and the outlet pressure and inlet flow rate estimates are used for detection; and ii) the inlet and outlet pressure measurements are used as boundary conditions and the inlet and outlet flow rate estimates are used for detection. In this way, the boundary conditions to be used in the numerical simulator of the flow inside the pipeline are defined, based on the Method of Characteristics (MoC). With this simulator integrated into the Particle Filter, the respective estimates are obtained at the pipeline inlet and outlet, which are compared with the existing experimental data.

In the results presented, 100 particles were used in the Particle Filter in order to keep the computational time compatible with the physical time. The particles were generated by adding noise extracted from a Gaussian distribution, with zero mean and standard deviation equal to the deadband of the respective state variable. The experimental uncertainties of the measurements are given by the standard deviations equal to the deadbands for the pressure and for the flow, when available.

The redundant DETECTION techniques can be applied to the history and not only in real time.

From the instants identified with the leak alarm by the DETECTION, the LOCATION is executed.

As with DETECTION, the LOCATION uses more than one technique to increase confidence and obtain redundant result. Therefore, LOCATION techniques are used by negative pressure wave analysis, optimization methods and artificial intelligence.

In LOCATION by optimization methods, the invention searches the measurement history for data close to a registered DETECTION. These pipeline behavior data are used as input for the simulator that calculates the possible states for a variety of leaks in positions distributed along the pipeline, performs statistical inferences seeking the leak position and time that most closely approximate the computational simulations to the operational measurements using a Bayesian optimization method that minimizes the differences between the simulations and the event actual measurement.

For the LOCATION, methods of statistical inferences are used, in which, preferably but not restricted to this, the Monte Carlo Method with Markov Chains (MCMC) was used, within a Bayesian approach and using the Method of Characteristics (MOC). It was possible to impose boundary conditions at the inlet and outlet of the extended pipeline, for the calculation of flows and pressures at the measurement points. Alternatively, the maximum method was used a posteriori.

For a total length of 60,760.49 m, the pressure of 2 24.83 kgf/cm was imposed at the pipeline inlet and the flow rate was imposed at the pipeline outlet, where it is considered that there is a valve. The outlet flow imposed with the valve open was 0.3 m³/s. To impose the water hammer on the pipeline, the valve was closed in a time of 900 s, wherein its closure was linear and lasting 10 s. The total time considered in the simulation was 3000 s. The initial condition corresponds to the permanent regime resulting from the pressure of 24.83 kgf/cm at the pipeline inlet and the flow rate of 0.3 m³/s at the pipeline outlet. In this extended pipeline, the sensors are located at position 1,002.1 m and at position 59,754.03 m.

The pressure of the sensor at the pipeline inlet and the flow rate of the sensor at the pipeline outlet were also used as boundary conditions in the solution of the inverse problem. The simulated measurements containing experimental errors, used in the solution of the inverse problem, were the inlet sensor flow and the outlet sensor pressure. Measurements are considered available with an acquisition frequency of 1 Hz. It was also considered that the measurements have additive and Gaussian errors, with zero averages and known standard deviations, equal to the deadbands of the informed sensors.

Leaks were considered in the positions Xleak=7.95 km, Xleak=30 km or Xleak=50 km, which start at a time of 61 s. Such leak positions refer to the distances taken from the beginning of the pipeline section. The simulated measurements for pressure and flow rate, in the sensors located at the pipeline inlet and outlet, which result from simulated leaks in the positions Xleak=7.95 km, Xleak=30 km and Xleak=50 km.

For the results presented below, Markov chains were simulated with 10,000 states and the heating period was taken to be 2,000 states. Seeking to analyze challenging cases, where information about the leak position is not known, a uniform distribution was considered a prior. The Markov chain was always started at the pipeline midpoint, that is, at position 29,375.9 m.

FIG. 5 shows the results obtained for a leak at 7,950 m, including the Markov chain (a) and the histogram after the heating period a posterior (b). It can be noted that the Markov chain tends towards an equilibrium distribution close to the exact value of the leak, which is 7,950 m. In fact, it is noted in FIG. 5 (b) the influence of the likelihood function, which provides the information of the measurements for the estimate so that, from the initial state of the Markov chain (leakage position at 29,375.97 m) results in the a posteriori with an average of 7,277.8 m and standard deviation of 2.74 m.

FIG. 6 shows the results obtained for a leak at 30,000 m, including the Markov chain (a) and the a posteriori histogram after the heating period (b). In this case, as the initial state of the chain is very close to the leak value, the chain tends towards an equilibrium distribution with average of 29,219.01 m and standard deviation of 5.57 m. The histogram of the equilibrium distribution shows a small uncertainty in the estimate obtained.

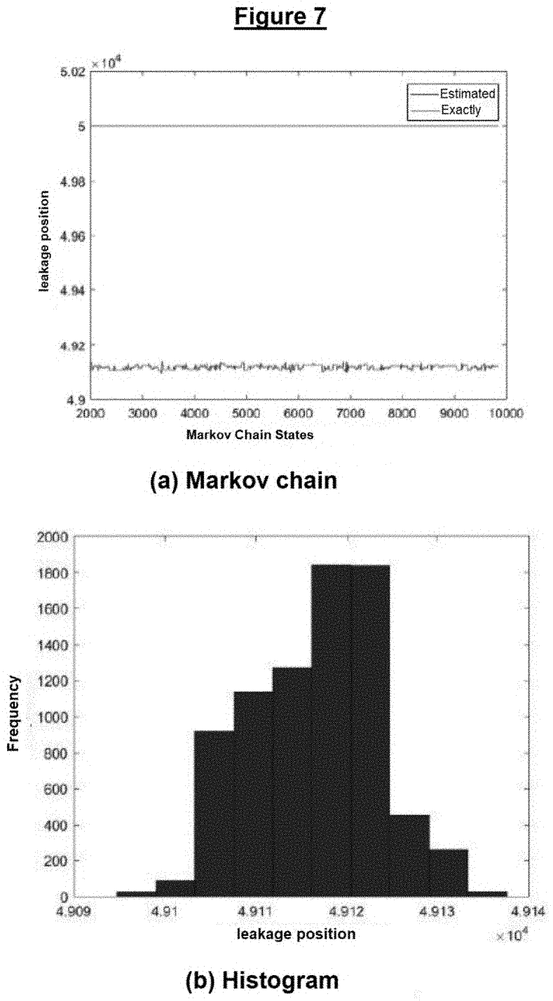

FIG. 7 shows the results obtained for a leak in 50,000 m, including the Markov chain (a) and the a posterior histogram after the heating period (b). As in the cases shown above, FIG. 7 show the robustness of the MCMC method for estimating the leak position. The estimated leak position was 49,116.56 m (average of the a posterior distribution), with a standard deviation of 6.96 m, even starting from an initial state of 29,375.97 m for the chain and considering simulated measurements with experimental errors similar to those that occur in practice.

The present invention proposes the previously described method in conjunction with the machine learning technique Evolutionary Neural Network (EvoNN), for the location of liquid leaks in the hydraulic circuit.

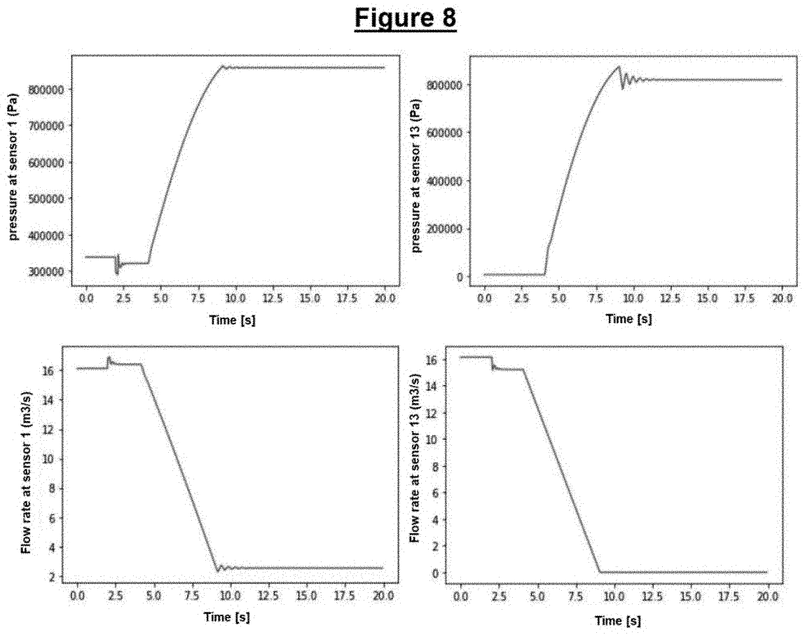

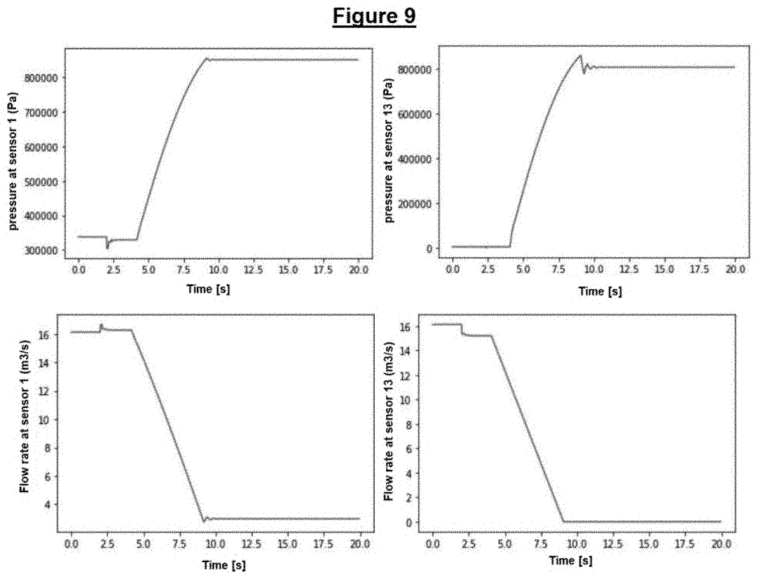

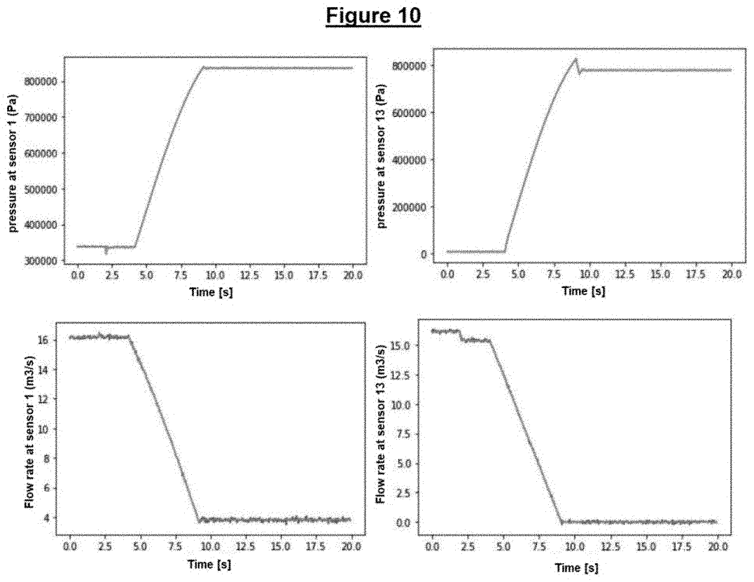

In FIGS. 8 and 9, we see the pressure and flow rate transients at the inlet (sensor 1) and outlet (sensor 13) of the circuit, calculated with the complete model, for two case examples in which only the position of the leak varies. In the first case, the leak occurs at 37.6973 m from the beginning of the circuit and in the second, at 75.89465 m.

As previously described, the flow starts in the steady state and, therefore, with constant flow rate and pressure. The difference in pressure is due to the difference in height between the beginning and end of the circuit and due to the various pressure drops caused by friction with the walls, curves and the presence of accessories, such as valves and sensors. Within 2 seconds of flow, when the leak starts, oscillations occur in all measurements and the flow rate at the circuit inlet increases, while the flow rate at the circuit exit decreases. The difference in flow rate is expected, due to mass conservation. We can observe, however, that the pressure oscillation at the circuit inlet is visibly greater than at the exit. In the first case, the outlet oscillation is so small that it can hardly be seen on the scale of the graph. This is because the position of the leak is much closer to the sensor at the inlet.

After 4.1 seconds of flow, the flow control valve closing starts at the end of the circuit, when we observed a rapid increase in pressure. The closing duration of 5 seconds was modeled as a linear decrease in the flow rate, for this reason, we see that the flow rate drops linearly to zero. From 9.1 seconds, when the closing of the valve ends, we begin to observe the effects of water hammer. The propagation of negative pressure waves causes oscillations in both pressure and flow rate. The magnitude of the oscillations is much greater at the end of the circuit, in both cases, since the valve which closure caused the water hammer is positioned at the end of the circuit, much closer to sensor 13 than to sensor 1.

The negative pressure waves are dissipated due to viscous effects and, while the oscillations decay, the pressures tend to stabilize at the values in which the oscillations were centered. The outlet flow rates oscillate centered on zero, assuming negative values, which indicates that the flow oscillates changing direction until it stops completely. Inlet flows stabilize at positive values very close to zero, due to the leak. As we can see, the position of the leak seems to influence the dissipation of pressure waves and, the closer the leak is to the outlet, the faster the dissipation occurs. In the final seconds of the flow, it is no longer possible to observe pressure or flow rate oscillations and, in 20 seconds, the flow is stopped, that is, with zero flow rates and constant pressures.

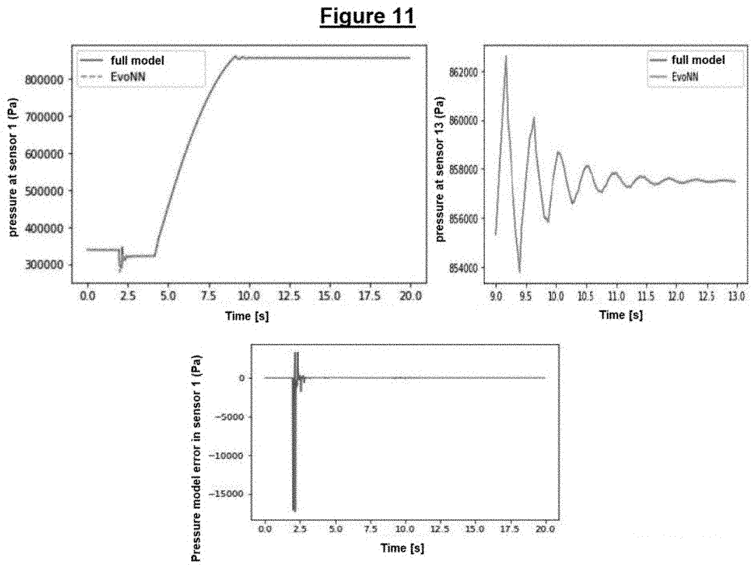

For the use of numerical solutions instead of experimental measurements in the solution of the inverse problem, Gaussian noise was added with zero average and standard deviation equal to 0.08 m³/s for the volumetric flow rate and 800 Pa for the pressure. In FIG. 10, we see the simulated measures.

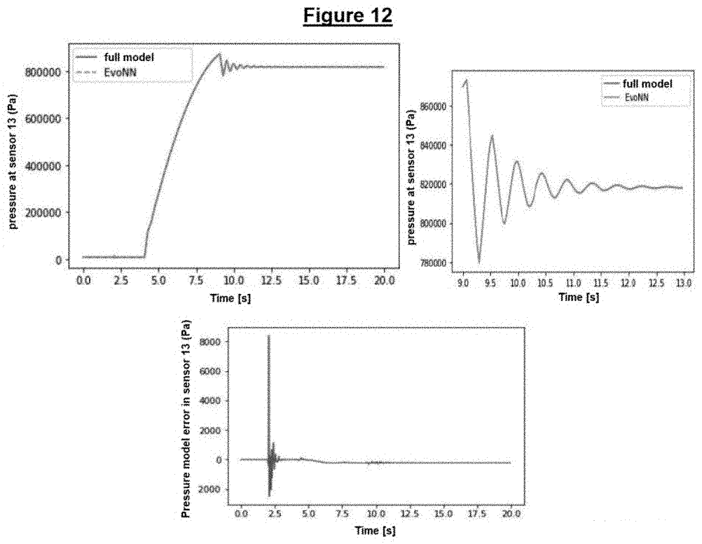

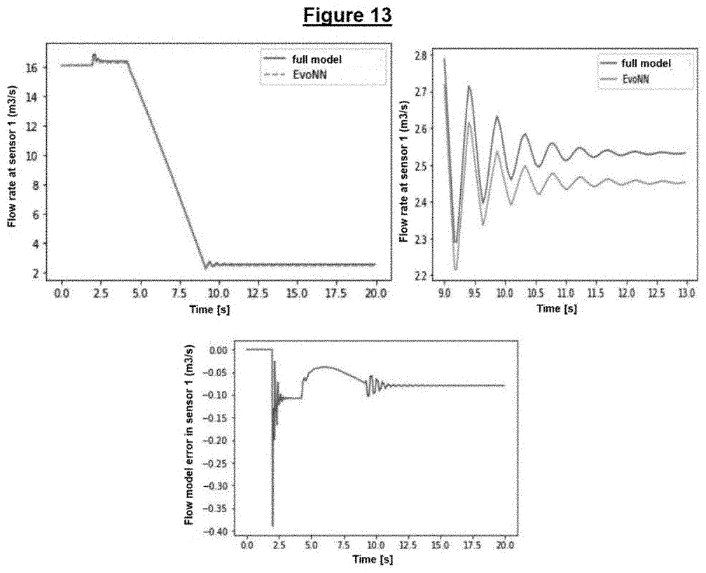

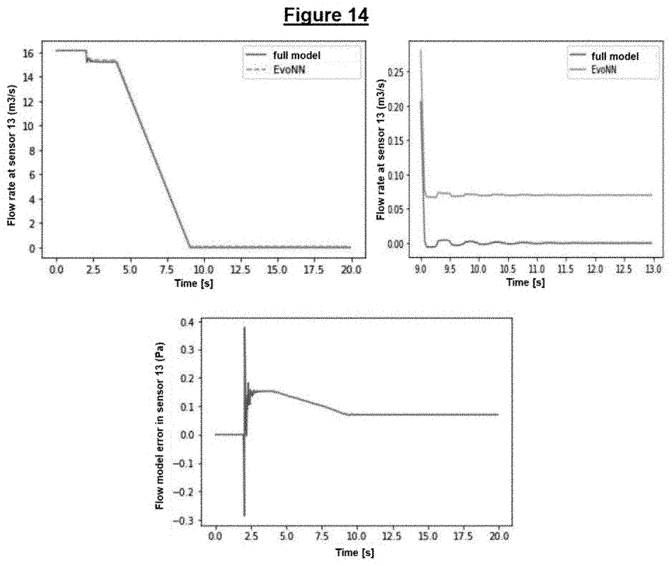

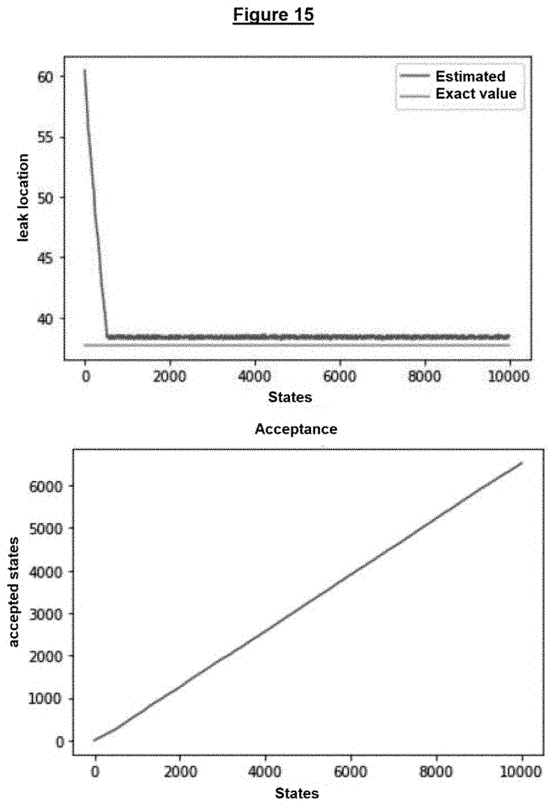

For analysis of the EvoNNs performance, 3 test cases are presented, in which only the leak position varies. In FIGS. 11 to 14, we see the results of the direct problem with the complete model and with the EvoNNs, for a leak positioned at 37.6973 meters away from the beginning of the circuit. Each figure shows an enlarged graph in the interval where the oscillations caused by the water hammer occur (b) and the difference between the two solutions, that is, the modeling error (c).

The graphs show that the EvoNNs can simulate the pressure behavior throughout the flow, properly reproducing the magnitudes of the oscillations, the wavelengths and the speed in which the pressure waves dissipate. The maximum error occurs close to the instant in which the leak starts and has an absolute value of 17302.44 Pa, which corresponds to only 5% of the pressure value at this time instant.

In the flow results we observed a small systematic error. As we see in FIG. 9b, the flow rate calculated by EvoNN oscillates around the value of 2.45 m³/s, after closing the valve. Meanwhile, the result of the complete model oscillates around 2.53 m³/s. At the circuit outlet (FIG. 10b), the EvoNN result oscillates around 0.07 m³/s, while the complete model oscillates around zero. Despite the displacement, EvoNNs can reproduce the wavelengths and amplitudes and the way pressure waves dissipate. The maximum flow error also occurred close to the moment of the leak and has an absolute value of 0.3897 m³/s, or 2.4% of the flow rate value at this point.

Another 2 test cases were also tested, with leaks located at 75.89465 and 114.092 meters from the beginning of the circuit and the results were equivalent. The EvoNNs managed to reproduce the behavior of the pressure waves and the flow as a whole, presenting a small systematic error in the flow rate. In all cases, the maximum error occurred just after 2 seconds of flow, in the oscillation caused by the beginning of the leak. In Table 4, we see the maximum errors and root mean square errors of each transient in each test case.

TABLE 4
Model errors in the three test cases.

| | | Pressure | Pressure | Flow rate | Flow rate |
|---|---|---|---|---|---|
| | | on sensor | on sensor | on Sensor | on Sensor |
| | | 1 (Pa) | 13 (Pa) | 1 (m³/s) | 13 (m³/s) |
| Case 1 | RMSE | 1025.16 | 422.76 | 0.0762 | 0.093 |
| | Max error | 17302.44 | 8393.30 | 0.3897 | 0.379 |
| Case 2 | RMSE | 574.52 | 1377.33 | 0.173 | 0.095 |
| | Max error | 9774.23 | 9063.80 | 0.257 | 0.504 |
| Case 3 | RMSE | 1526.71 | 2137.39 | 0.044 | 0.060 |
| | Max error | 5576.38 | 12633.87 | 0.264 | 0.427 |

To solve the inverse problem, the Monte Carlo method via Markov Chain (MCMC) with the Metropolis-Hastings algorithm was applied. The estimated parameter is the position of the leak, and the computationally simulated measurements are pressure and flow rate transients at the beginning and end of the circuit. Uniform a priori was used for the position of the leak, in the range of [0, 150.7893], which includes the entire length of the hydraulic circuit. To generate candidates for each state, a proposal of the random walk type with Gaussian distribution was defined, with zero mean and standard deviation equal to 0.02 multiplied by the value of the parameter in the current state of the chain. For all test cases, 10000 states were generated and the location value in the initial state was randomly generated from the a priori.

FIG. 15 shows the results generated for the first test case (leak at 37.6973 m). We see that the Markov Chain starts at 60,455 m and quickly approaches the exact value. From approximately 1000 states, when the heating period of the chain ends, the values oscillate in a well-behaved way with low variance, however, slightly displaced from the exact value. In Table 5, we see the results of the average and standard deviation of the chain states after the heating, the 99% credibility interval and the acceptance rate.

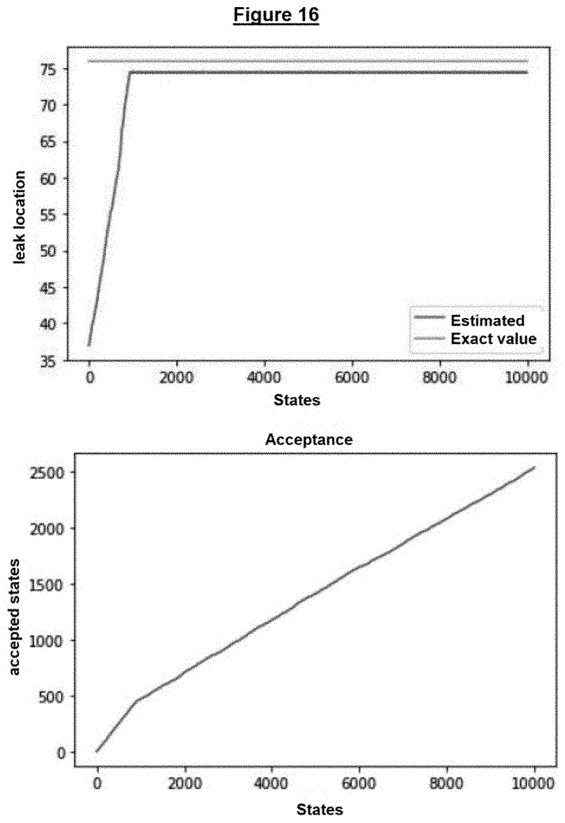

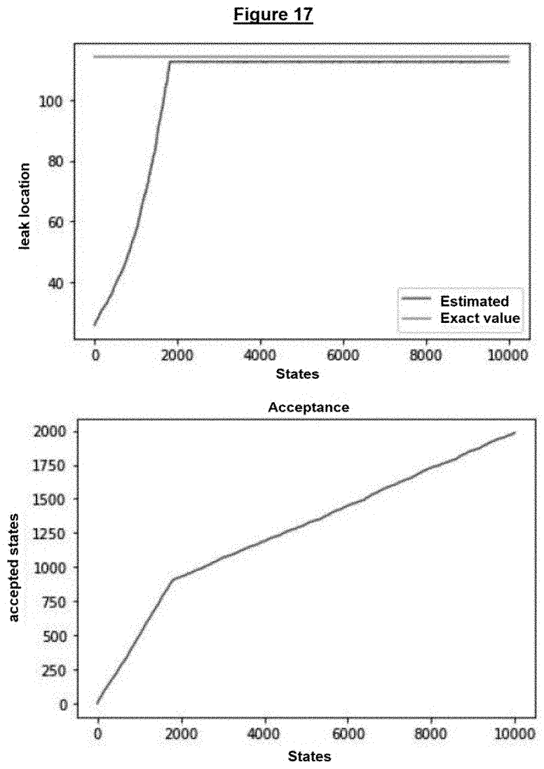

In FIGS. 16 and 17, we see the Markov chains and acceptance rates for the second and third test cases. In all cases, the chain starts from initial states far from the exact values, which shows that the method works independently of the initial state and does not converge to local minima. Furthermore, the error is low, having reached its maximum value in the third case, in which the estimated location is only 2.4 meters away from the exact position of the leak. Table 5 presents the results extracted from the chain for all cases.

TABLE 5
Leak position estimation results with MCMC

| | Case 1 | Cass 2 | Cass 3 |
|---|---|---|---|
| Exact location | 37.6973 | 75.89465 | 114.092 |
| Initial state | 60.455 | 36.933 | 25.839 |
| Average | 38.378 | 74.393 | 112.5059 |
| (Standard deviation) | (0.066) | (0.0287) | (0.0246) |
| Percentiles | [38.21 38.54] | [74.32 74.46] | [112.44 112.56] |
| Acceptance | 65.2% | 25.31% | 19.84% |
| Comp. Time (s) | 13.04 | 12.24 | 8.38 |

The observed model error and, consequently, the error in the location estimates, may be associated with the low number of training samples or limitations of the metamodel. In addition to increasing the number of training samples, the use of the Approximation Error Model (AEM) technique is proposed. As metamodels do not exactly reproduce the behavior of the complete models, in the AEM approach, the statistical model of the approximation error is built and represented as additional noise in the measurement model (KAIPIO and SOMERSALO, 2006, ORLANDE, 2015). Error modeling can be especially interesting in the case of data-driven metamodels, as the hard task of generating large amounts of training data can be an obstacle to improving the training of learning machines.

The objective of reducing the computational cost of the inverse problem solution was also achieved. Table 6 shows the computational times for each stage of the process. To calculate the solution of the direct problem with the complete model, it takes 1093 seconds, while the same task is completed in 0.021 seconds with the EvoNNs. Consequently, the Metropolis-Hastings algorithm for 104 states requires only 9 seconds. The costliest steps are the generation of training samples and the training of neural networks. These steps, however, will not need to be done again.

TABLE 6
Computational time for each process step

| | Time [seconds] |
|---|---|
| Direct problem for 1 sample with complete model | 1093 |
| Generation of the 300 training samples | 327800 |
| Training of the 4 EvoNNs | 5396 |
| Direct problem for 1 sample with EvoNNs | 0.021 |
| Metropolis-Hastings algorithm with 10000 states | 8.8 |

The invention also uses, for the location of leaks, Neural Networks with Physical Information to solve herein the Poiseuille flow and heat conduction problems in a two-dimensional plate.

A second method for LOCATION uses an Artificial Intelligence by neural network, where there is a training of a leak metamodel and then, the identification of the location of the leak point. A third method for LOCATION is the negative pressure wave, in which the arrival time of the negative pressure wave, or rarefaction, created by the opening of a leak along the pipeline section is measured. By calculating the arrival time of the wave at each end, it is possible to estimate the position of the leak. The negative pressure wave and the artificial intelligence method provide less accurate results, but they are practically instantaneous results and are used by the system as initial estimates for the optimization method, which achieves results even when fast methods fail.

The present invention has the advantage and ability to reduce the leaked volume and the time to search for leaks, contributing to mitigate environmental impacts caused by hydrocarbons. In addition to reducing contractual fines.

1. A observation system, characterized by comprising a sensor communication module (1), statistical tools (2) for compensation of measurement and model uncertainties, automatic leak detection techniques (3), graphical user interface (5), measurement sensors (6), leak locator (4), flow simulator (7), historical database (8).

2. The system, according to claim 1, characterized in that the sensor communication module (1) receives the field data from the measurement sensors (6) and forwards it to the statistical tools (2).

3. The system according to claim 1, characterized in that the statistical tools (2) is responsible for automatically compensating for errors and delivering measurements for automatic leak detection techniques (3).

4. The system according to claim 1, characterized in that automatic leak detection techniques (3) analyses the measurement data from the sensor communication module (1) or the historical database (8), through previously trained pattern detection through the flow simulator (7).

5. The system according to claim 1, characterized in that, if there is a leak, it actuates the leak locator (4) for its location in space and time.

6. The system according to claim 1, characterized in that the command and results are made by graphical interface (5), which in turn also displays the leaks in a georeferenced way.

7. The system according to claim 1, characterized by using a code in Python to characterize leaks in the pipeline comprising:
1. Reading measurements from the sqlite database for a user-specified period of time;
2. Correction of the specific mass measured in Guararema;
3. Correction of the measured volume flow in Guararema and Guarulhos;
4. Synchronization of all data to 00:00:00 (HH:MM:SS) of the chosen start date for searching in the database;
5. Conversion of dates and times to seconds, counting from 00:00:00 (HH:MM:SS) of the initial date chosen for searching in the database;
6. Completion of data every second;
7. Calculation of the moving averages of measurements every second; and
8. Calculation of event indicator codes in the pipeline.

8. The system according to claim 1, characterized in that a program developed in Python detects the leak receiving as inputs the initial and final dates and times of the period to be analyzed.

9. The system according to claim 1, characterized by a program developed in Python comprising:
1. database connection to import pressure, volumetric flow and specific mass measurements, at the beginning and end of the pipeline, for the selected period;
2. correction of systematic error in specific mass in Guararema;
3. correction of isolated null values in the flow rate;
4. if there is no measurement at the initial instant of the analyzed period, the first measurement available in the period is used at this instant;
5. measurements are completed every second, repeating the previous measurement;
6. calculation of moving averages every 5 seconds, to reduce the influence of noise;
7. calculation of pressure derivatives;
8. calculation of the 5 leak indicators (pipe stopped, difference in mass flow, difference in volumetric flow, non-zero derivative at inlet, non-zero derivative at outlet); and
9. prediction of the probability of having a leak with the neural network; 10. agglomeration of nearby alarms.

10. The system according to claim 1, characterized in that it uses the Particle Filter method, where the idea is to represent a posteriori the probability density function by a set of random samples (particles) with associated weights and obtain estimates based on these samples and weights.

11. The system according to claim 1, characterized in that, in the leak location step, it uses the Monte Carlo Method with Markov Chains (MCMC) within a Bayesian approach and uses the Method of Characteristics (MOC).

12. The system according to claim 1, characterized in that it uses the method of Maximum a Posterior, in the leak location step.

13. The system according to claim 1, characterized in that it uses, in the leak location step, Neural Networks with Physical Information.

14. The system according to claim 1, characterized in that it uses, in the leak location step, Artificial Intelligence by neural network.

15. The system according to claim 1, characterized in that it uses, in the leak location step, the negative pressure wave, wherein the arrival time of the negative pressure wave, or the rarefaction time, created by the opening of a leak along the pipeline section are measured.
